(19) United States
(12) Patent Application Publication
(10) Pub. No.: US 2017/0251462 A1
(43) Pub. Date: Aug. 31, 2017

(54) UPLINK NON-ORTHOGONAL MULTIPLE ACCESS SCHEME AND JOINT RECEPTION SUPPORTING SCHEME

(71) Applicant: Samsung Electronics Co., Ltd, Gyeonggi-do (KR)

(72) Inventors: Sung-Ho Chae, Seoul (KR); Cheol Jeong, Gyeonggi-do (KR); Peng Xue, Gyeonggi-do (KR); Nam-Jeong Lee, Gyeonggi-do (KR)

(21) Appl. No.: 15/442,562

(22) Filed: Feb. 24, 2017

(30) Foreign Application Priority Data
Feb. 25, 2016 (KR) 10-2016-0022423

(51) Int. Cl. H04W 72/04; H04B 7/06; H04B 17/336

(52) U.S. Cl. CPC H04W 72/0413; H04B 17/336; H04B 7/0613; H04W 88/06

(57) ABSTRACT

Disclosed is a 5G or a pre-5G communication system provided to support a higher data transmission rate than a system after a 4G communication system such as LTE. A method of a first BS supporting non-orthogonal multiple access and joint reception includes: allocating transmission resources for signal transmission of a first UE and a second UE serviced by the first BS and transmitting information on the allocated transmission resources to a second BS; transmitting the information on the allocated transmission resources to the first UE and the second UE; receiving a signal of the first UE and a signal of the second UE based on the information on the allocated transmission resources; and decoding the received signal of the first UE and the received signal of the second UE, wherein resources by which the signal of the first UE is transmitted overlap with a part of resources by which the signal of the second UE is transmitted.

### CROSS-REFERENCE TO RELATED APPLICATION(S) AND CLAIM OF PRIORITY

The present application is related to and claims priority under 35 U.S.C. §119(a) to Korean Application Serial No. 10-2016-0022423, which was filed in the Korean Intellectual Property Office on Feb. 25, 2016, the entire content of which is hereby incorporated by reference.

### TECHNICAL FIELD

The present disclosure relates to a non-orthogonal multiple access scheme and a joint reception scheme for improving uplink communication performance.

### BACKGROUND

In order to meet wireless data traffic demands that have increased after the commercialization of 4th Generation (4G) communication systems, efforts to develop an improved 5G communication system or a pre-5G communication system have been made. For this reason, the 5G communication system or the pre-5G communication system is called a beyond 4G network communication system or a post LTE system.

In order to achieve a high data transmission rate, implementing the 5G communication system in a mmWave band (for example, 60 GHz band) is being considered. In the 5G communication system, technologies such as beamforming, massive MIMO, Full Dimensional MIMO (FD-MIMO), array antenna, analog beam-forming, and large scale antenna are being discussed as means to mitigate a propagation path loss in the mm Wave band and increase a propagation transmission distance.

Further, technologies such as an evolved small cell, an advanced small cell, a cloud Radio Access Network (cloud RAN), an ultra-dense network, Device to Device communication (D2D), Internet of Things (IoT), a wireless backhaul, a moving network, cooperative communication, Coordinated Multi-Points (CoMP), and interference cancellation have been developed to improve the system network in the 5G communication system.

In addition, the 5G system has developed Advanced Coding Modulation (ACM) schemes such as Hybrid FSK and QAM Modulation (FQAM) and Sliding Window Superposition Coding (SWSC), and advanced access technologies such as Filter Bank Multi Carrier (FBMC), Non Orthogonal Multiple Access (NOMA), and Sparse Code Multiple Access (SCMA).

An uplink Joint Reception (UL JR) scheme is a scheme in which a plurality of BSs jointly receives uplink signals transmitted from a UE, and may be called joint reception or cooperative reception. In the joint reception scheme, it is possible to increase the data rate and uplink communication reliability by allocating resources that a first BS does not currently use to a UE that receives a service from a second BS.

The UL JR scheme is actively being discussed as a name of uplink coordinate multi point (UL CoMP) reception in 3rd generation partnership project (3GPP) Rel. 8 and Rel. 11. Recently, the UL JR scheme is being discussed as a technology related to the cellular internet of things (Cellular IoT: CIoT).

The UL JR scheme may be performed by reception operations of base station(s), and thus the UE may operate without knowing that the UE is receiving a joint reception (JR) service. BSs performing the UL JR scheme may share scrambling information (for example, scrambling sequence information), demodulation reference signal (DM-RS) setting information, or sounding reference signal (SRS) setting information used by other BSs with each other, and thus acquire channel information of UEs that receive the service from the other BSs.

In order to actually implement the UL JR scheme, the BSs should schedule resources to be used for the joint reception (that is, joint scheduling) and loads of the BSs may increase due to the joint scheduling.

Further, the BS that desires to perform the UL JR scheme should completely transmit information indicating whether transmission is successful (that is, ACK/NACK) to the UE within a predetermined time after performing both joint processing (joint reception) and joint decoding. For example, in the LTE standard, the BS should complete ACK/NACK transmission to the UE within 4 ms.

FIG. 1 illustrates cooperative BSs connected through an X2 interface.

In a connection between a Remote Radio Unit (RRU) and a Digital Unit (DU), a Common Public Radio Interface (CPRI) is connected through an optical fiber, and thus latency is much shorter than 0.5 ms. Accordingly, in an environment where only the RRU and the DU are used, a 4 ms ACK/NACK transmission condition can be sufficiently satisfied. However, when joint BSs 101 and 102 are connected through the X2 interface as illustrated in FIG. 1, backhaul latency may reach 10 to 20 ms, so that the 4 ms ACK/NACK transmission condition may not be satisfied.

Meanwhile, in a CIoT system, latency and a synchronization condition of a Hybrid Automatic Repeat and request (HARQ) is significantly mitigated compared to LTE. Accordingly, the application of the UL JR technology is easier in the CIoT system. According to the GSM EDGE Radio Access Network (GERAM) standard, an acceptable latency from a time point when the BS ends reception of a data packet to a time point when the BS starts transmission of an ACK/NACK packet significantly increases to 320 ms in the CIoT system. Further, an acceptable Cyclic Prefix (CP) length also increases from 4.7 μsec on the LTE standard to 25 μsec in the CIoT system.

However, even though an ACK/NACK transmission time condition of the CIoT system is greatly mitigated, the UL JR technology is not always applied. Performance improvement according to the application of the UL JR technology may be influenced by cell load. The BS in an environment having low cell load may apply the UL JR scheme to acquire a performance gain. That is, as the BS having low load allocates resources, which the BS does not currently use, to the UE receiving a service from the cooperative BS, the UE may acquire the performance gain. However, when the UL JR technology is applied to the BS in an environment having high cell load, transmission performance rather deteriorates. In other words, the BS in the environment having high cell load is better off not applying the UL JR technology (that is, to use resources of the BS for UL reception of the UE of the BS) in terms of resource efficiency of the total system rather than supporting UL reception of the UE of another BS by applying the UL JR technology.

The LTE system is suitable for applying the UL JR scheme in terms of traffic characteristics since cell load is low and smaller than 10% in an actual uplink. However, the CIoT system has high cell load compared to the LTE system since traffic operates mainly based on uplink. Accordingly, even though it is advantageous to apply the UL JR technology in the CIoT system because of significantly mitigated ACK/NACK transmission time conditions, the CIoT system may not acquire a high performance gain despite the application of the UL JR technology.

### SUMMARY

To address the above-discussed deficiencies, it is a primary object to make a BS acquire a high performance gain by applying both NoMA and JR.

Another objective of the present disclosure is to provide a new JR scheme by which the BS can acquire a high performance gain even in an environment in which the BS has a high load.

In accordance with an aspect of the present disclosure, a method of a first base station (BS) supporting non-orthogonal multiple access and joint reception is provided. The method includes: allocating transmission resources for signal transmission of a first user equipment (UE) and a second UE serviced by the first BS and transmitting information on the allocated transmission resources to a second BS; transmitting the information on the allocated transmission resources to the first UE and the second UE; receiving a signal of the first UE and a signal of the second UE based on the information on the allocated transmission resources; and decoding the received signal of the first UE and the received signal of the second UE, wherein resources by which the signal of the first UE is transmitted overlap with a part of resources by which the signal of the second UE is transmitted.

In accordance with another aspect of the present disclosure, an apparatus of a first BS supporting non-orthogonal multiple access and joint reception is provided. The apparatus includes: a transceiver configured to allocate transmission resources for signal transmission of a first user equipment (UE) and a second UE serviced by the first BStransmit information on the allocated transmission resources to a second BS, transmit the information on the allocated transmission information to the first UE and the second UE, and receive a signal of the first UE and a signal of the second UE based on the information on the allocated transmission resources; and a controller configured to decode the received signal of the first UE and the received signal of the second UE, wherein resources by which the signal of the first UE is transmitted overlap with a part of resources by which the signal of the second UE is transmitted.

According to the present disclosure, the BS may acquire a high performance again even though load of the BS is high.

According to the present disclosure, it is possible to increase the total capacity which the BS can process through the use of overlapping resources.

According to the present disclosure, the UE may have a higher transmission rate and transmission reliability by joint reception of the BS.

According to the present disclosure, the UE can reduce power consumption by the joint reception of the BS.

According to the present disclosure, the BS may perform the joint reception even in a state where load of the BS is high.

According to the present disclosure, when the BS performs the joint reception, the UE and the BS can reduce complexity.

According to the present disclosure, the BS performing the joint reception can reduce overhead of joint scheduling.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example joint base stations (BSs) connected through an X2 interface according to various embodiments of the present disclosure;

FIGS. 2A and 2B illustrates an example concept of performing random access channel (RACH) through a joint reception (JR) scheme in terms of a frequency re-use rate according to various embodiments of the present disclosure;

FIGS. 3A to 3C illustrates an example method of performing JR by adjacent BSs on RACH of the UE according to various embodiments of the present disclosure;

FIG. 4 illustrates a flowchart of a random access process according to various embodiments of the present disclosure;

FIG. 5 illustrates an example successive interference cancellation (SIC) operation of the BS according to various embodiments of the present disclosure;

FIGS. 6A to 6C illustrate an example diagrams of a method by which BS(s) decode data of a near UE and a far UE based on non-orthogonal multiple access (NoMA) and JR schemes according to various embodiments of the present disclosure;

FIG. 7 illustrates a flowchart of a method by which BSs perform NoMA+JR on signals of near user equipments (UEs) and a far UE according to various embodiments of the present disclosure;

FIG. 8 illustrates an example relationship between signal decoding failure of a near UE and a far UE signal re-transmission operation according to various embodiments of the present disclosure;

FIG. 9 illustrates a flowchart of a method by which a first BS support non-orthogonal multiple access and joint reception between BSs according to various embodiments of the present disclosure;

FIG. 10 illustrates an example configuration of the BS according to various embodiments of the present disclosure; and

FIG. 11 illustrates an example configuration of the UE according to various embodiments of the present disclosure.

### DETAILED DESCRIPTION

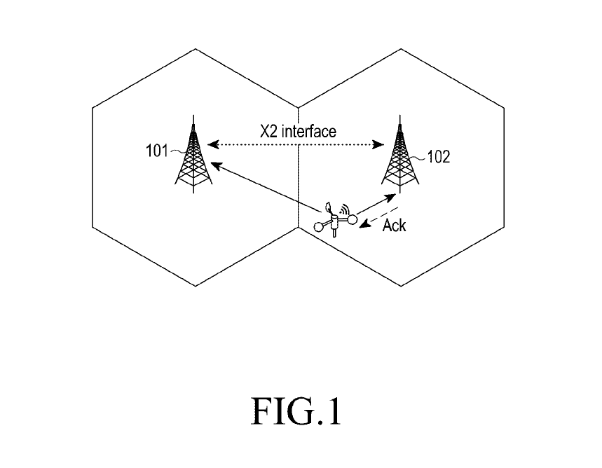

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, an embodiment of the present disclosure will be described in detail with reference to the accompanying drawings. In the following description of the present disclosure, a detailed description of known functions or configurations incorporated herein will be omitted when it may make the subject matter of the present disclosure rather unclear. The terms as described below are defined in consideration of the functions in the embodiments, and the meaning of the terms may vary according to the intention of a user or operator, convention, or the like. Therefore, the definitions of the terms should be made based on the contents throughout the specification.

A BS is a subject to allocate resources to a UE and receive UL data, and may be at least one of an eNode B, a Node B, a Base Station (BS), a wireless access unit, a BS controller, or a node on a network. In the present disclosure, one cell is serviced by one BS. Accordingly, cell may be considered to have the same meaning as BS according to some cases. For example, cell load may be used as the same meaning as BS load.

In the present disclosure, a UE may include a User Equipment (UE), a Mobile Station (MS), a cellular phone, a smart phone, a computer, and a multimedia system capable of performing a communication function.

A JR scheme according to the present disclosure may be applied to all processes including a process in which the UE initially accesses to the BS and a process in which the UE transmits and receives data to and from the BS.

First, in a process in which the UE performs random access (RACH) to the BS for an initial connection, the JR scheme according to the present disclosure is described.

When the UE turns off and then turns on power, the UE may perform the random access to acquire access grant of the BS in a case where the UE moves from one cell to another cell. Since interference may be generated between adjacent BSs when the BSs use the same frequency, the adjacent BSs may schedule to not overlap the frequencies. Further, the adjacent BSs may perform UL JR of RACH signals by using the same frequencies.

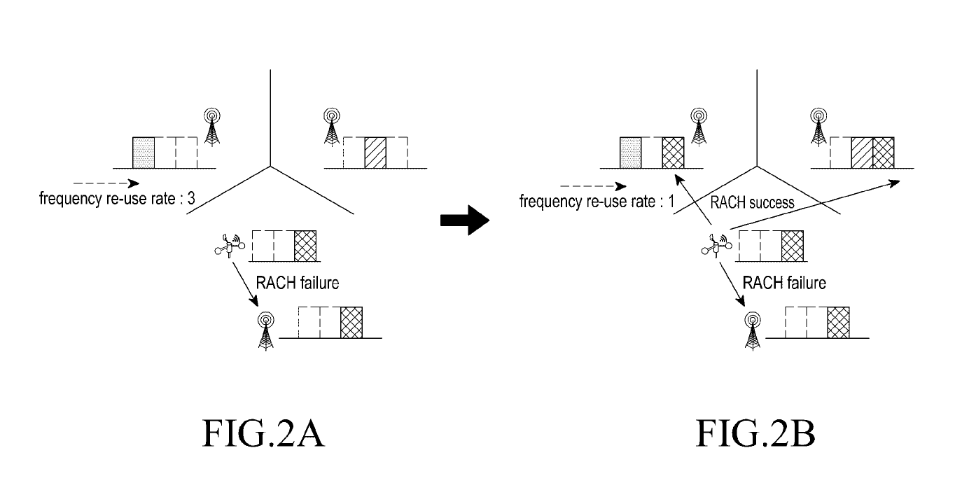

FIGS. 2A and 2B illustrate an example concept of performing RACH based on a JR scheme in terms of a frequency re-use rate according to various embodiments of the present disclosure.

FIG. 2A illustrates a case where a UE performs RACH with a frequency re-use rate of 3 in three adjacent cells. Here, the frequency re-use rate 3 means that three adjacent cells use separated frequency resources. Accordingly, the UE performing the RACH performs the RACH only for one cell, and RACH failure causes a delay. That is, although the UE has completed an access process, the UE has not acquired access grant for the BS and thus repeats the random access process and latency increases. For example, when overload is generated in the BS, the UE is more likely to fail in random access and latency for acquiring the access grant for the BS may significantly increase. The latency due to the RACH failure may be a critical problem to a UE to execute an application having a restriction on a delay (for example, a warning application to inform of an emergency situation).

FIG. 2B illustrates a case where the UE performs RACH with a frequency re-use rate of 1 in three adjacent cells. Here, the frequency re-use rate 1 means that the respective cells share resources and thus the UE attempts RACH in the adjacent cells. That is, since all the cells share frequency resources, although the UE fails in RACH in one cell, the UE may succeed in the RACH in another cell. When the random access of the UE is successful for at least one of the adjacent BSs, the UE acquires an access grant for the BS for which the random access has been successful. According to the present disclosure, the UE may decrease an access grant time for the BS and thus prevent a problem of the increase in latency.

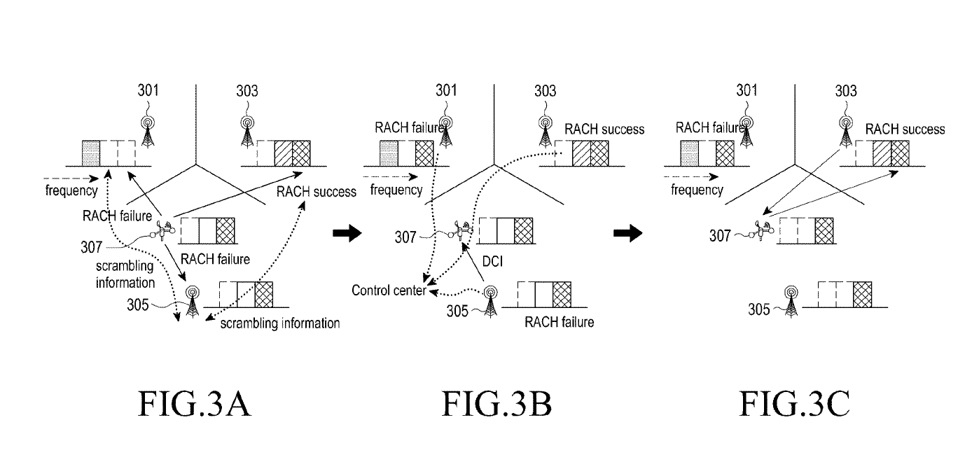

FIGS. 3A to 3C illustrate an example of a method by which adjacent BSs perform JR on RACH of the UE according to various embodiments of the present disclosure.

FIG. 3A illustrates a case where the UE performs RACH with a frequency re-use rate of 1 for three adjacent BSs 301, 303, and 305. First, the three adjacent BSs 301, 303, and 305 may allocate cooperative RACH resources to perform JR and share scrambling information. Among the three adjacent BSs 301, 303, and 305, the serving BS 305 of a UE 307 indicates a location of the cooperative RACH resources to the UE 307. The UE 307 performs RACH by using the cooperative RACH resources. Since the cooperative RACH resources of the three adjacent BSs 301, 303, and 305 are the same, the UE 307 has a result of independent performance of RACH for each of the three adjacent BSs 301, 303, and 305. At this time, the following operations are described based on an assumption that the UE 307 fails in the RACH for two adjacent BSs 301 and 305 of the three adjacent BSs 301, 303, and 305, and succeeds in the RACH only for one adjacent BS 303.

FIG. 3B illustrates a case where the UE succeeds in the RACH for one adjacent BS among the adjacent BSs. The three adjacent BSs 301, 303, and 305 share information on whether the UE 307 succeeds in the RACH or not through a control center. The serving BS 305 may transmit information (that is, Downlink Control Information (DCI)) required for access to the adjacent BS 303 for which the UE 307 has succeeded in the RACH to the UE 307.

FIG. 3C illustrates a case where the UE communicates with the adjacent BS for which the UE has succeeded in the RACH. After the UE 307 accesses the adjacent BS 303, the UE 307 may directly receive DCI from the adjacent BS 303 and communicate with the adjacent BS 303.

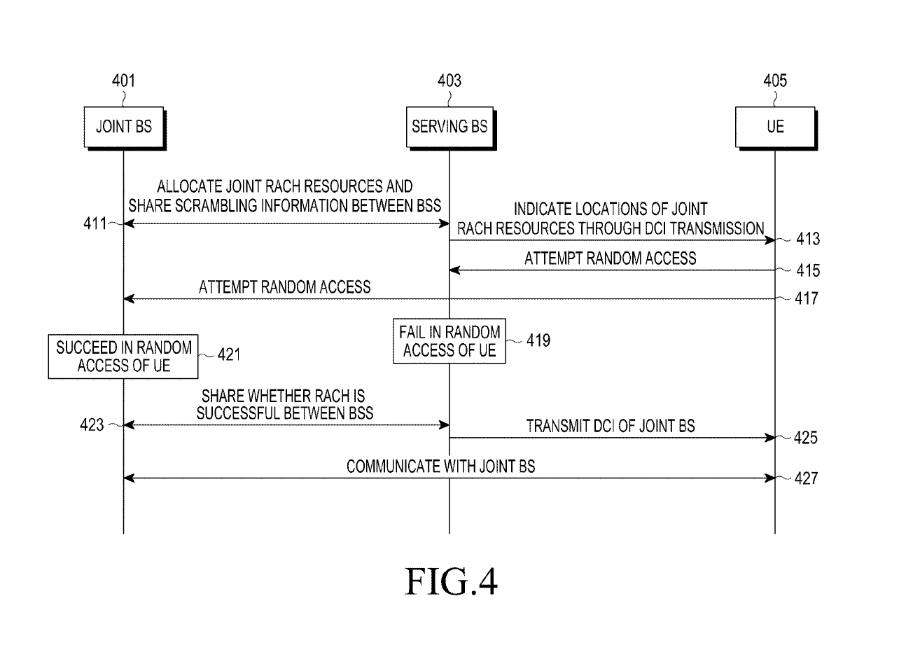

FIG. 4 illustrates a flowchart of a random access process according to various embodiments of the present disclosure.

Referring to FIG. 4, it is assumed that a serving BS 403 corresponding to a BS of a cell that serves a UE 405, a joint BS 401 corresponding to a BS of adjacent another cell, and the UE 405 exist on the network.

The serving BS and the joint BS may perform joint scheduling to allocate resources to the UE. That is, the serving BS 403 and the joint BS 401 may allocate joint RACH resources for performing JR in step 411. At this time, the serving BS 403 may share (that is, exchange) scrambling information with the joint BS 401. The shared scrambling information may be used for processing an RACH signal received from the UE 405 by the serving BS 403 and the joint BS 401. Selectively, the serving BS may further perform an operation of compensating for a difference of a synchronization time point from the joint BS or an operation of compensating for a propagation delay.

Each of the serving BS 403 and the joint BS 401 may indicate a location of the joint RACH resources to at least one UE (for example, the UE 405) based on the DCI in step 413. The UE 405 transmits the RACH signal to the serving BS 403 and the joint BS 401 and performs the random access in steps 415 and 417.

When the UE 405 fails in RACH attempt for the serving BS 403 in step 419 and succeeds in RACH attempt for the joint BS 401 in step 421, the serving BS 403 and the joint BS 401 may transmit/receive a message and share whether the random access of the UE 405 is successful in step 423. The serving BS 403 may transmit information (that is, DCI) required for access to the joint BS 401 for which the RACH attempt is successful to the UE 405 in step 425.

The UE 405 may communicate with the joint BS 401 based on the DCI received from the serving BS 403.

The BS may apply the JR scheme to a non-orthogonal multiple access (NoMA) scheme. According to the present disclosure, the NoMA scheme corresponds to a scheme for, when the BS allocates resources to the UE, allocating resources (non-orthogonal resources) overlapping resources of another UE, so as to support multiple access. For example, in the NoMA scheme, the BS may allocate non-orthogonal time or frequency resources to the UE and the other UE. Through the application of the NoMA scheme, signals received by a plurality of UE may overlap each other. Accordingly, the BS may perform a successive interference cancellation (SIC) operation or an interference cancellation (IC) operation for removing an interference signal from an overlappingly received signal in order to acquire a desired signal.

Further, when the NoMA scheme is applied to the JR scheme, the BS may perform an operation for determining UEs to which the NoMA scheme is applied, that is, pairing of a near UE and a remote UE in order to acquire optimal performance. The near UE and the far UE correspond to UEs overlappingly using the same resources according to the NoMA scheme, and may be determined based on a location of the UE within a cell or a minimum required received SINR. Hereinafter, for convenience, a UE having a high minimum required received SINR is referred to as a near UE and a UE having a low minimum required received SINR is referred to as a far UE. Division of the near UE and the far UE is determined based on the SINR and, in general, the near UE is often located at the center of the cell and the far UE is often located at the edge of the cell. However, since the near UE and the far UE have different required MCSs despite being located in similar positions, the near UE and the far UE may have different minimum required received SINRs.

When the BS executes the NoMA scheme, the SIC operation should be necessarily performed and a power difference is used for determining an interference signal in the SIC. Accordingly, it is preferable that UEs having a large minimum required received signal to interference plus noise ratio (SINR) are selected as UEs to be paired.

Further, the BS may perform an operation for determining a UE to receive a UL signal through the JR scheme.

There are three cases where the BS performs the UL JR. First, the BS may perform the UL JR when the UE makes a request for the JR. Second, the BS may perform the UL JR when the BS determines that the UL JR is needed. Third, the BS may perform the UL JR when the BS determines in advance to perform the UL JR with an adjacent BS and allocates resources in advance. The above three cases will be described below in more detail.

First, when the UE desires to acquire a transmission rate higher than a modulation and coding scheme (MCS) which can be provided in a current channel state or desires to acquire a higher reception reliability with the fixed MCS, the UE may make a request for performing the UL JR to the BS.

In order to guarantee the MCS requested by the UE, the BS may perform the UL JR in consideration of path loss to the UE, a cell load degree, or an MCS. Alternatively, in contrast, the BS may calculate a gain of the UE in advance and notify the UE that provision of the requested UL JR is not possible. For example, when the BS determines that the requested MCS cannot be met even if the UL JR is performed based on the calculation of a maximum gain of the UE which can be acquired through the UL JR, the BS may notify the UE that the provision of the requested UL JR is not possible. The gain which the UE can acquire through the UL JR may be calculated by the BS in every communication in consideration of a difference of the path loss to the UE, a difference of the MCS, or load of the BS or may be determined by checking a look up table that has been pre-calculated and stored.

Further, when the BS can provide a service (for example, guarantee the MCS) according to a request of the UE due to low cell load, the BS may independently allocated resources to every UE (without applying the NoMA scheme) and may apply the JR scheme as necessary. In contrast, when cell load is high, the BS may apply the NoMA within a range in which the MCS requested by the UE can be met.

Further, when the BS schedules the UE through the application of the NoMA scheme, the BS may assign a priority to the guarantee of the performance of UEs having made a request for the JR and may transfer a power control command to the UE without any problem of SIC as necessary. The power control command transferred by the BS will be described below.

Second, the BS may determine whether to perform the UL JR.

When the number of UEs to which the BS provides the service increases, the BS may perform load balancing to control the number of serviced UEs. For example, the load balancing may include handover of a part of the UEs to another BS from the BS. Further, for example, the load balancing may include a coverage class change and performance of the JR by the BS. When the number of UEs of a particular coverage class increases, the BS may not satisfy MCSs of all of the many UEs. Accordingly, the BS may change all or some of the coverage class of the UEs belonging to the particular coverage class (for example, move the UEs to a higher coverage class) and satisfy the MCSs of the UEs of which the coverage class has been changed through the JR scheme. Here, the coverage class corresponds to a group determined based on a coverage to which the UE belongs and may be divided into a plurality of classes based on, for example, the size of a path loss between the BS and the UE. For example, the coverage class may be a coverage class reset by the BS in consideration of the JR and the NoMA during a random access process of the UE.

As described below, in order to increase a capacity of the BS, the BS may control transmitted power of the UE or adjust the number of repetitions of transmission and notify the UE of the adjusted number of repetitions. Further, the BS may directly recommend (that is, provide) an enhanced MCS which can be acquired through the UL JR to the UE through signaling and increase the total capacity of the BS.

Third, resources for the UL JR scheme may be allocated in advance. When BSs jointly allocate resources to perform the UL JR and apply the NoMA scheme to the allocated resources, the MCS to be used may be preset. The BSs may inform the UE of the preset MCS through DCI. Since the BS executes the NoMA scheme and the JR scheme by using the pre-allocated resources, a power control and an MCS rule may be newly defined. For example, the BS may define the rule to use only binary phase shift keying (BPSK) or 16 quadrature amplitude modulation (QAM) for a particular resource block (RB) to perform the UL JR. For example, the BS may define the rule to reduce transmitted power in half and increase the number of repetitions two times for the RB using the BPSK and to increase transmitted power to be 2 dB for the RB using the 16QAM compared to using another RB.

Only when a particular condition (for example, a condition that path loss is larger than or equal to a predetermined value) is met will the UE may perform access by using the allocated resources or follow the defined power control and MCS rule. Since the resources for the JR have been already allocated, joint scheduling between BSs for allocating JR resources is not performed when the JR of the UE is performed and, as a result, overhead generated due to the joint scheduling may be prevented.

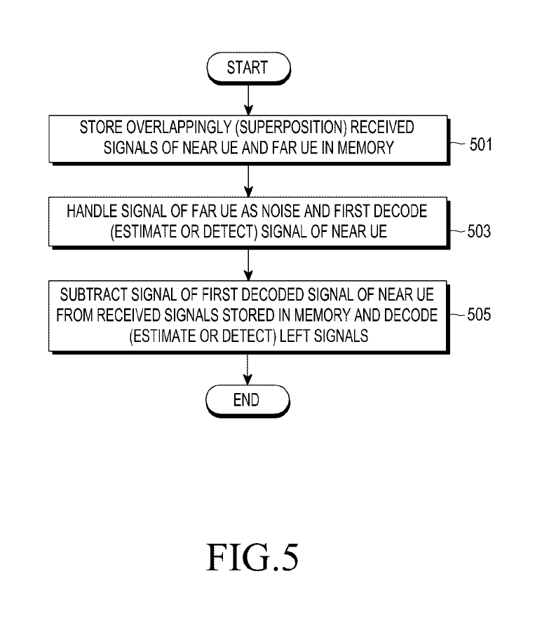

FIG. 5 illustrates an example SIC operation of the BS according to various embodiments of the present disclosure.

FIG. 5 illustrates a method by which the BS performs SIC when the near UE and the far UE overlappingly access the same resources through the application of an NoMA scheme (that is, UL signals are overlappingly transmitted on the same resources).

The BS stores overlappingly (superposition) received signals of the near UE and the far UE in a memory in step 501. The signal of the far UE may be repeatedly received and may overlap signals of different near UEs in every repetition.

The BS handles the signal of the far UE as noise and first decodes (estimates or detects) the signal of the near UE in step 503.

The BS subtracts (removes) the decoded signal of the near UE from the received signals stored in the memory and decodes (estimates or detects) the left signals in step 505. It may be noted that the decoded signal from the left signals is the signal of the far UE.

At this time, conditions under which the BS successfully performs the SIC operation are as follows.

$$\begin{matrix}equation ( 1 ) & \\ • \frac{{P}_{far}}{{N}_{0}} \geq {SINR}_{far} & ( 1 ) \\ • \frac{{P}_{near}}{{N}_{0} + {P}_{far}} \geq {SINR}_{near} & ( 2 ) \\ {•P}_{near} \geq {SINR}_{near} ( {N}_{0} + {P}_{far} ) \geq {SINR}_{near} ( {N}_{0} + {SINR}_{far} {N}_{0} \text{/} {G}^{′} ) & ( 3 )\end{matrix}$$

respectively, SINR_{far} and SINRₙₑₐᵣ denote minimum required received SINRs (required SINRs considering JR gains) to meet required MCSs of the far UE and the near UE, respectively, N₀ denotes power of noise, and G′ denotes an additional coding gain that may be acquired through transmission repetition. For example, G′ may be calculated by Gⱼ*Gᵣ. Gⱼ denotes a factor generated by the application of the JR scheme, and Gᵣ denotes a factor generated through transmission repetition.

When the above conditions can be met through scheduling of the BS alone based on the conventional power control rule, there is no need to perform a separate power control. However, otherwise, it may be required to adjust the power control for the NoMA and the JR. For example, when the BS determines to perform the UL JR or the UE transmits a UL JR request to perform the UL JR, the adjustment of the power control of the NoMA and the JR may be followed.

Such a power control method of the BS (that is, power scheduling) will be described below.

Before adjusting the power control for the NoMA and the JR, the BS checks whether received power of the near UE meets SIC condition (3) of the equation based on a path loss and preset transmitted power.

When SIC condition (3) is not met, 1) the BS may increase transmitted power of the near UE or 2) may increase the number of repetitions of the transmission while reducing transmitted power of the far UE (that is, increase G′), so as to meet SIC condition (3). At this time, when Pₙₑₐᵣ varies whenever the transmission of the signal of the far UE is repeated (for example, when the signal of the near UE and the repeated signal of the far UE having different MCSs overlap each other), the BS may set P_{far} to meet SIC condition (3), calculate total SINR_{far} based on SIC condition (1), and then determine the number of repetitions required. Further, in the NoMA scheme, when the decoding of the near UE fails, a success probability of the decoding of the far UE may also decrease due to characteristics of the scheme. Accordingly, a method of securing reliability by further increasing the number of repetitions of transmission of the far UE may be considered.

However, when the increase in the number of repetitions larger than or equal to a threshold value or the increase in transmitted power of the near UE larger than or equal to a threshold value is needed, the BS may not apply the NoMA scheme. Further, whether to perform the JR may be determined based on a degree of the gain of the UE.

When such a power control method is required, the BS may directly inform the UEs of it, or may make a look up table including received power and a required change amount of the number of repetitions according to MCS pair between the near UE and the far UE or an MCS set (tuple) and share the look up table with the UEs. Then, the UEs may check the table and make a determination by themselves.

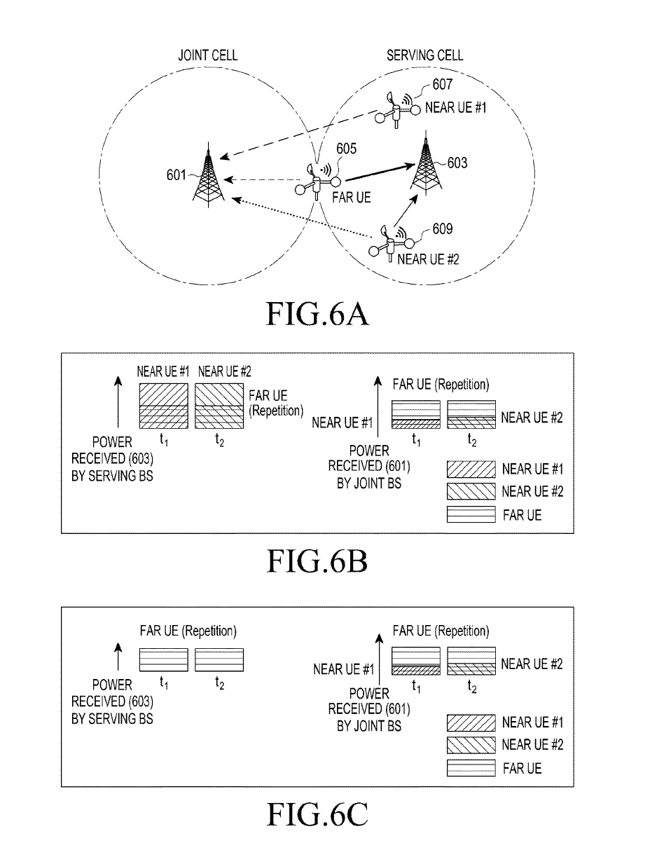

FIGS. 6A to 6C illustrate an example of conceptual diagrams of a method by which BS(s) decode data of a near UE and a far UE based on NoMA and JR schemes according to the present disclosure.

In FIG. 6A, a joint BS 601, a serving BS 603, a remote UE 605, near UE #1 607, and near UE #2 609 are included.

FIG. 6B shows signals of the far UE 605 and UEs #1 and #2 607 and 609 overlappingly received on time resources t1 and t2 of the joint BS 601 and the serving BS 603 along with received power sizes.

Referring to FIG. 6A, the serving BS 603 is close to near UE #1 607 and near UE #2 609 and is spaced apart from the far UE 605. Accordingly, strength of power of the serving BS 603 received from near UEs #1 and #2 607 and 609 is larger than strength of power received from the far UE 605 in FIG. 6B. In the serving BS 603, the transmission resources of time t1 are overlappingly used by near UE #1 607 and the far UE 605, and transmission resources of time t2 are overlappingly used by near UE #2 609 and the far UE 605.

Referring to FIG. 6A, the joint BS 601 is spaced apart from near UE #1 607 and near UE #2 609 and is close to the far UE 605. Accordingly, strength of power of the joint BS 601 received from the far UE 605 is larger than strength of power received from near UEs #1 and #2 607 and 609 in FIG. 6B. In the joint BS 603, the transmission resources of time t1 are overlappingly used by near UE #1 607 and the far UE 605, and transmission resources of time t2 are overlappingly used by near UE #2 609 and the far UE 605.

A decoding method of the serving BS through the JR+NoMA scheme may be performed by the following steps.

<step 1: NoMA step> the serving BS 603 decodes signals of near UEs #1 and 2 607 and 609 while handling the signal of the far UE 605 as noise in the received signals illustrated in FIG. 6B and subtracts (removes) the decoded signals of near UEs #1 and #2 607 and 609 from the received signals. Since the serving BS 603 performs power scheduling such that there is a sufficient difference in received power of near UEs #1 and #2 607 and 609 and the far UE 605, a decoding success probability of the signals received from near UE #1 and #2 607 and 609 is as high as when independent resources are used even though overlapping resources are used. FIG. 6C illustrates a state where the decoded signals of near UEs #1 and #2 607 and 609 are removed from the received signals. That is, it is noted that only the signal from the far UE 605 has left in the serving BS 603. Selectively, the serving BS may transfer (information on) the decoded signals of near UEs #1 and #2 607 and 609 to joint BS(s) through an X2 interface.

<step 2: Joint Reception (JR) step> the serving BS 603 and the joint BS 601 perform a joint decoding (or joint reception or joint processing) of the far UE 605. At this time, the joint BS 601 may decode the signal of the far UE 605 while handling the signals of near UE #1 607 and near UE #2 609 as noise. Since a path loss of the signals of near UE #1 607 and near UE #2 609 is very big to the joint BS 601, decoding performance is hardly influenced even though the signals of near UE #1 607 and near UE #2 609 are handled as noise. The joint decoding of the serving BS 603 and the joint BS 601 has, for example, the following two alternatives. A first alternative is maximum rate combining. The maximum rate combining corresponds to a joint decoding method by which respective BSs combine received signals to make a signal to noise ratio (SNR) maximum. At this time, an optimal decoding performance can be achieved. A second alternative is selection combining. The selection combining corresponds to a method by which respective BSs perform an independent decoding based on received signals received and, when at least one of the BSs succeeds in the decoding, consider that the transmission is successful. The maximum rate combining is more excellent than the selection combining in terms of the performance. However, the maximum rate combining requires an exchange of data (the signal of the near UE, the signal of the far UE, or the SNR) between the BSs and thus has high complexity, and thus may be selectively applied when necessary.

<step 3: near UE decoding re-attempt step-selective> even though the serving BS 603 or the joint BS 601 fail in decoding data received from near UE#1 607 or near UE #2 609, the serving BS 603 or the joint BS 601 may succeed in decoding data received from the far UE 605. For example, joint reception by the selection combining is performed by a plurality of joint BSs, and thus has a high probability of succeeding in the decoding. In this case, by performing SIC processing on the successfully decoded signal of the far UE 605, an SINR of the signal of near UE #1 607 or the signal of near UE #2 609 may increase. Accordingly, the serving BS 603 may re-attempt the decoding of the signal of near UE #1 607 or the signal of near UE #2 609 of which the SINR has increased, and may succeed in decoding the signal of near UE #1 607 or the signal of near UE #2 609.

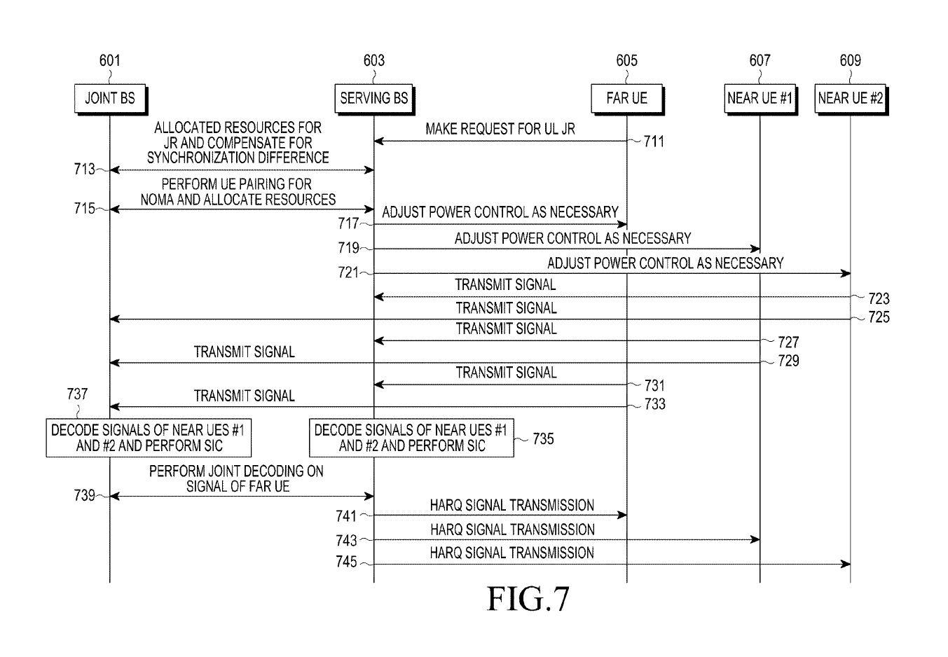

FIG. 7 illustrates a flowchart of a method by which BSs perform NoMA+JR on signals of near UEs and a far UE according to various embodiments of the present disclosure.

The far UE 605 may make a request for UL JR to the serving BS 603 in step 711.

The serving BS 603 may perform an operation for allocating resources to perform a JR scheme with the joint BS 601 and an operation for compensating for a synchronization difference between the BSs in step 713.

Further, the serving BS 603 and the joint BS 601 may perform pairing of the UE for NoMA or a resource allocation operation in step 715.

The serving BS 603 may adjust (reset) a power control for the far UE 605 if needed in step 717. The serving BS 603 may adjust a power control of near UE #1 607 or near UE #2 609 as necessary in step 719 or 721.

Near UE #2 609 may transmit a signal (for example, an RACH signal) to the serving BS 603 and the joint BS 601 in steps 723 and 725. Near UE #1 607 may also transmit a signal (for example, an RACH signal) to the serving BS 603 and the joint BS 601 in steps 727 and 729. The far UE 605 may also transmit a signal (for example, an RACH signal) to the serving BS 603 and the joint BS 601 in steps 731 and 733.

The serving BS 603 or the joint BS 601 may decode the signal of near UE #1 607 and the signal of near UE #2 609 from the received signals and perform SIC of removing the decoded signals from the received signals in steps 735 and 737. At this time, the signal received from the far UE 605 may be processed as noise.

The serving BS 603 and the joint BS 601 perform joint decoding on the signal of the far UE 605 in step 739. At this time, the joint BS 601 may process the signals of near UE #1 and near UE #2 607 and 609 as noise. The serving BS 603 may transmit an HARQ signal for UL transmission to near UE #1 607, near UE #2 609, or the far UE 605 in step 741, 743, or 745.

HARQ signal transmission of the BS will be described below.

The BS may fail in decoding the signal received from the near UE or fail in decoding the signal received from the far UE. Alternatively, the BS may fail in both decoding the signal received from the near UE and decoding the signal received from the far UE. Even though the BS fails in decoding the signal received from the near UE, the BS may succeed in decoding the signal received from the far UE. However, since the decoded signal of the near UE is used for decoding the signal of the far UE, the failure of the decoding of the signal received from the near UE by the BS may significantly influence a success probability of the decoding of the signal received from the far UE.

When the BS fails only in decoding the signal received from the near UE, the near UE may re-transmit the signal according to an already known HARQ scheme. At this time, the near UE may re-transmit the signal through an NoMA scheme similar to initial transmission. However, when a channel state is not good, the BS may configure the near UE to re-transmit the signal through an orthogonal multiple access (OMA) (user-specific independent resource allocation) scheme in the re-transmission.

When the BS fails only in decoding the signal received from the far UE, the far UE may be configured to re-transmit the signal through the OMA scheme. Thereafter, joint reception of the far UE signal is performed by the BSs or the far UE may be configured to transmit again only a packet part having the worst channel state among the repeatedly transmitted packets.

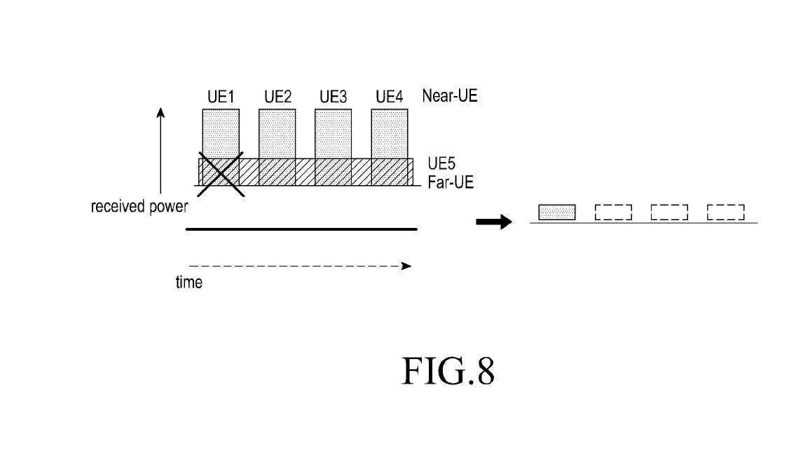

When the BS fails in both decoding the signal received from the near UE and decoding the signal received from the far UE, the near UE and the far UE may be differently handled. The signal of the near UE may be re-transmitted according to an already known HARQ scheme or re-transmitted according to an NoMA scheme. The far UE may re-transmit the signal by the number of times corresponding to the number of transmissions of the near UEs for which the decoding is failed as illustrated in FIG. 8. At this time, the far UE may apply a network coding between packets and a forward error correction (FEC) rather than repeatedly simply re-transmitting data. The BS may determine the number of repetitions in consideration of the network coding between the data packets and the FEC and notify the far UE of the determined number of repetitions.

FIG. 8 illustrates an example relation between failure of the signal decoding of the near UE and the far UE signal re-transmission operation according to various embodiments of the present disclosure.

FIG. 8 illustrates a case where there are four near UEs and the BS fails in a decoding for only one near UE (UE #1) among the four near UEs. At this time, the far UE may perform one time data re-transmission based on the number of decoding failures.

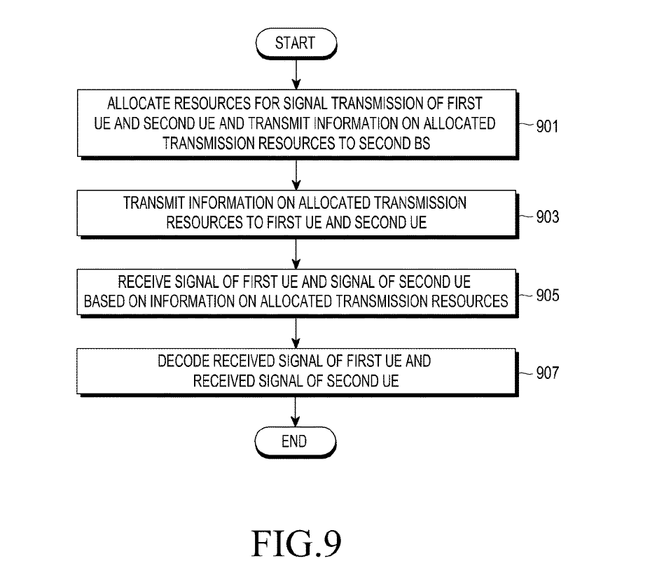

FIG. 9 illustrates a flowchart of a method by which a first BS supports non-orthogonal multiple access and joint reception between BSs according to various embodiments of the present disclosure.

The first BS allocates resources for signal transmission of the first UE and the second UE and transmits information on the allocated transmission resources to the second BS in step 901. The signal may be a signal for performing RACH.

The first BS transmits the information on the allocated transmission resources to the first UE and the second UE in step 903.

The first BS receives the signal of the first UE and the signal of the second UE based on the information on the allocated transmission resources in step 905.

The first BS decodes the received signal of the first UE and the received signal of the second UE in step 907. Specifically, the first BS processes the signal of the second UE as noise and decodes the signal of the first UE. Thereafter, the first BS removes the decoded signal of the first UE from the received signal of the first UE and the received signal of the second UE and decodes the signal of the second UE in the removed signal.

The first BS may further include an operation of re-setting power for the first UE or the second UE. The first UE is a UE located close to the first BS and the second UE may be located at the edge of a cell covered by the first BS. Alternatively, a UE having a relatively larger minimum required received SINR may be the second UE and a UE having a relatively smaller minimum required received SINR may be the first UE.

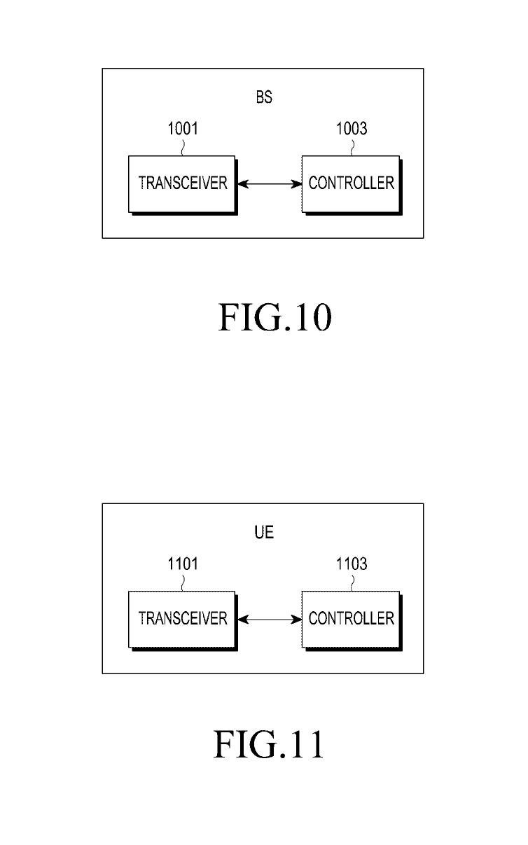

FIG. 10 illustrates an example configuration of a BS according to various embodiments of the present disclosure.

For convenience of description, illustration and description for elements having no direct relation with the present disclosure will be omitted. Referring to FIG. 10, the BS may include a transceiver 1001 and a controller 1003. While the following operations are separately performed by a plurality of elements herein, all the following operations may be performed by one element as necessary. The transceiver 1001 may receive a signal transmitted by the UE and transmit a signal such as DCI to the UE. The controller 1003 may be construed as performing all operations of the BS described in the present disclosure. For example, the controller 1003 may decode data received from the near UE and perform SIC.

Although the transceiver 1001 and the controller 1003 are separately illustrated for easy understanding, the transceiver 1001 and the controller 1003 may be implemented as one element.

FIG. 11 illustrates an example configuration of a UE according to various embodiments of the present disclosure.

For convenience of description, illustration and description for elements having no direct relation with the present disclosure will be omitted. Referring to FIG. 11, the UE may include a transceiver 1101 and a controller 1103. While the following operations are separately performed by a plurality of elements herein, all the following operations may be performed by one element as necessary. The transceiver 1101 may receive a signal transmitted by a BS and transmit a JR request signal to the BS. It may be construed that the controller 1103 performs all the operations of the UE described in the present disclosure.

Although the transceiver 1101 and the controller 1103 are separately illustrated for easy understanding, the transceiver 1101 and the controller 1103 may be implemented as one element.

Meanwhile, the exemplary embodiments disclosed in the specification and drawings are merely presented to easily describe technical contents of the present disclosure and help the understanding of the present disclosure and are not intended to limit the scope of the present disclosure. That is, it is obvious to those skilled in the art to which the present disclosure belongs that different modifications can be achieved based on the technical spirit of the present disclosure. Further, if necessary, the above respective embodiments may be employed in combination.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of a first base station (BS) supporting non-orthogonal multiple access and joint reception, the method comprising:
allocating transmission resources for signal transmission of a first user equipment (UE) and a second UE serviced by the first BS and transmitting information on the allocated transmission resources to a second BS;
transmitting the information on the allocated transmission resources to the first UE and the second UE;
receiving a signal of the first UE and a signal of the second UE based on the information on the allocated transmission resources; and
decoding the received signal of the first UE and the received signal of the second UE,
wherein resources by which the signal of the first UE is transmitted overlap with a part of resources by which the signal of the second UE is transmitted.

2. The method of claim 1, further comprising resetting power for at least one of the first UE or the second UE.

3. The method of claim 1, wherein the decoding the received signal of the first UE and the received signal of the second UE comprises:
processing the signal of the second UE as noise and decoding the signal of the first UE;
removing the decoded signal of the first UE from the received signal of the first UE and the received signal of the second UE; and
decoding the signal of the second UE in the removed signal.

4. The method of claim 1, wherein the first UE is located close to the first BS, and wherein the second UE is located at an edge of a cell covered by the first BS.

5. The method of claim 1, wherein a minimum required received signal to interference plus noise ratio (SINR) of the second UE is larger than a minimum required received SINR of the first UE.

6. The method of claim 1, wherein the transmission resources for the signal transmission of the first UE and the second UE are parts of transmission resources allocated in advance for joint reception between BSs.

7. The method of claim 1, further comprising receiving a joint reception request message between BSs from the second UE.

8. The method of claim 1, wherein decoding the received signal of the first UE and the received signal of the second UE comprises:
receiving the signal of the first UE decoded by the second BS; and
decoding the signal of the second UE using the signal of the first UE decoded by the second BS.

9. The method of claim 1, wherein decoding the received signal of the first UE and the received signal of the second UE comprises:
determining a number of times by which the signal of the first UE is repeatedly transmitted in accordance with whether the decoding of the signal of the second UE fails or not; and
transmitting the determined number of times by which the signal of the first UE is repeatedly transmitted to the first UE.

10. The method of claim 1, further comprising transmitting, to each of the first UE and the second UE, information on whether the decoding of the signal of the first UE and the signal of the second UE is successful or not.

11. An apparatus of a first BS supporting non-orthogonal multiple access and joint reception, the apparatus comprising:
a transceiver configured to:
allocate transmission resources for signal transmission of a first user equipment (UE) and a second UE serviced by the first BS and transmit information on the allocated transmission resources to a second BS;
transmit the information on the allocated transmission resource to the first UE and the second UE;
receive a signal of the first UE and a signal of the second UE based on the information on the allocated transmission resources; and
a controller configured to decode the received signal of the first UE and the received signal of the second UE,
wherein resources by which the signal of the first UE is transmitted overlap with a part of resources by which the signal of the second UE is transmitted.

12. The apparatus of claim 11, wherein the controller is further configured to reset power for at least one of the first UE or the second UE.

13. The apparatus of claim 11, wherein the controller is further configured to:
process the signal of the second UE as noise, decodes the signal of the first UE:
remove the decoded signal of the first UE from the received signal of the first UE and the received signal of the second UE; and
decode the signal of the second UE in the removed signal.

14. The apparatus of claim 11, wherein the first UE is located close to the first BS, and wherein the second UE is located at an edge of a cell covered by the first BS.

15. The apparatus of claim 11, wherein a minimum required received signal to interference plus noise ratios (SINR) of the second UE is larger than a minimum required received SINR of the first UE.

16. The apparatus of claim 11, wherein the transmission resources for the signal transmission of the first UE and the second UE are parts of transmission resources allocated in advance for joint reception between BSs.

17. The apparatus of claim 11, wherein the transceiver receives a joint reception request message between BSs from the second UE.

18. The apparatus of claim 11, wherein:
the transceiver is further configured to receive the signal of the first UE decoded by the second BS; and
the controller is further configured to decode the signal of the second UE using the signal of the first UE decoded by the second BS.

19. The apparatus of claim 11, wherein the controller is further configured to determine a number of times by which the signal of the first UE is repeatedly transmitted in accordance with whether a decoding of the signal of the second UE fails or not, and the transceiver transmits the determined number of times by which the signal of the first UE is repeatedly transmitted to the first UE.

20. The apparatus of claim 11, wherein the transceiver is further configured to transmit, to each of the first UE and the second UE, information on whether a decoding of the signal of the first UE and the signal of the second UE is successful or not.
